(19) United States
(12) Patent Application Publication
(10) Pub. No.: US 2009/0125398 A1
(43) Pub. Date: May 14, 2009

(54) METHODS OF COMPUTING ADVERTISING VALUE THROUGH REAL-TIME AUCTION

(76) Inventors: William Cochran, Champaign, IL (US); Stuart Stubblebine, Madison, NJ (US)

Correspondence Address: MICHAEL BEST & FRIEDRICH LLP, 100 E WISCONSIN AVENUE, Suite 3300, MILWAUKEE, WI, 53202, US

(21) Appl. No.: 12/256,930

(22) Filed: Oct. 23, 2008

Related U.S. Application Data
(63) Continuation-in-part of application No. 12/139,938, filed on Jun. 16, 2008.
(60) Provisional application No. 60/963,149, filed on Aug. 2, 2007.

(51) Int. Cl. G06Q 30/00; H04L 9/00

(52) U.S. Cl. 705/14; 705/50

(57) ABSTRACT

A method of soliciting and receiving a bid for placement of an ad on a web browser. The method includes receiving a request from the browser to serve an ad, the request from the browser including information describing browsing activity of the browser. The method also includes soliciting a bid from the at least one advertiser for placement of an ad on the browser; receiving at least one bid from the at least one advertiser for placement of an ad on the browser; evaluating the at least one bid; and placing an ad from at least one advertiser on the browser based on the evaluation of the at least one bid.

### CROSS-REFERENCE TO RELATED APPLICATIONS

This application is a continuation-in-part of U.S. patent application Ser. No. 12/139,938, filed Jun. 16, 2008, which claims the benefit of U.S. provisional application No. 60/963,149, filed Aug. 2, 2007, both of which are incorporated herein by reference in their entirety.

### FIELD OF THE INVENTION

The present invention relates to tracking online advertising and in particular to methods for assessing whether online advertising activity is legitimate and determining a fair price for the activity based on legitimacy.

### BACKGROUND OF THE INVENTION

Since the inception of the World Wide Web, many people have tried to harness its advertising potential. One method for harnessing this is the pay-per-click advertising model. However, many pay-per-click business models are susceptible to abuse.

Under a typical pay-per-click advertising model, advertisers agree to pay a server configured to provide linked advertisements on commercial web sites (a “content server”) for advertising that is presented to specific demographic groups. The content server places the advertiser's advertisements on the web sites where they are clicked by individuals seeking more information about the advertisers and their goods and services. Generally, under the terms of the agreement, the advertiser agrees to pay the content server a small fee each time a user clicks on one of the advertiser's advertisements. The content server then compensates the web site that presented the advertisement.

This model has at least two deficiencies: 1) there is no mechanism to reliably detect and account for web site operators who click on advertisements served on their web pages, and 2) there is no system that ensures that appropriate advertisements are served to a particular web page. Without explicit prevention, users of pay-per-click advertising models must trust the content server to isolate and remedy fraudulent clicks.

As an example of a common type of fraud associated with pay-per-click advertising models, certain malicious individuals may set up web sites designed to look like credible web sites that might contain information about a particular product or industry. For example, such an individual could lease a domain name that is a common misspelling of the domain name of a credible web site.

Once such a site is set up, malicious individuals can wait for users to find the web site and click on the advertisements (a legitimate business model) or manufacture clicks using known mechanisms. For instance, in some countries it is cost effective to hire people to click on advertisements on these web sites. No matter what mechanism is used, the result is that the advertiser is paying for clicks by Internet users that have no intention of viewing the advertiser's web content.

One remedy to this situation is for the content server to recognize what is transpiring. Certain web usage patterns are easy to identify and many who attempt to defraud pay-per-click advertising models are caught. However, for some advertisers this is not an adequate solution because the fraudulent activities are not discovered until a relatively long time after they have occurred and the advertiser must rely on the content server to alert them to the activity. Therefore, it would be useful to have a system that allows for Internet advertisers to detect fraudulent clicks on their advertisements in real time so that the advertiser can contact the content server and report the fraudulent activity immediately.

Another concern with pay-per-click advertising models involves advertisements that appear on a competitor's web site. Many commercial web site owners use content servers to place advertisements on their own web sites. However, it is also possible that a competitor's advertisement will be served to their web site. Such a scenario is unpalatable for the commercial web site owner because it allows a competitor to advertise its products and services using the web site and resources of the commercial web site owner. Content servers have developed very sophisticated algorithms to prevent this from occurring. However, in some cases the only way for a commercial web site owner to verify the results of these algorithms is to frequently click on all of the advertisements served to its web site to ensure that none belong to its competitors. Distinguishing between those looking for competitors on their web site and those driving up the number of advertisement clicks on their web site is not possible within the framework of current pay-per-click advertising models. Therefore, it would be useful to have a system which permits advertisers to verify that its competitor's advertisements are not displayed on its web site, without being accused of committing click fraud.

### SUMMARY OF THE INVENTION

An improved system would allow advertisers to identify good-faith clicks on their advertisements as they happen so that they can be priced appropriately. The immediacy of the determination means content servers will distribute less money based on bad faith clicks.

Embodiments of the invention approach these problems by establishing non-intrusive protocols requiring that browsers perform a small amount of work before they present an advertisement to an Internet user. The protocols provide for the transfer of secure information between the browser and the content server. This information can be used to store metrics that provide insight into an Internet user's intent when they click or select an advertisement. Furthermore, these protocols require that content servers provide receipts to advertisers at the time that an advertisement is clicked. These receipts contain information that the advertiser can use to determine the legitimacy of clicks on its advertisements. The protocols presented by embodiments of the invention provide tradeoffs between features and complexity. These protocols are relatively lightweight, and can be implemented using common and well understood web development tools such as the Common Gateway Interface (“CGI”) for server side processing and AJAX or Javascript on the browser side. Persistent data can be stored at the client in cookies (such as HTTP cookies) and in databases at the server side.

Embodiments of the invention provide methods, systems, and apparatuses for discerning the legitimacy of a click on an advertisement by the user of a browser. In particular, embodiments of the invention provide methods and systems for using encrypted data to store information concerning the interactions between a browser and a server, and a mutating identifier which the server uses to decrypt the data. At least two protocols are implemented: an Ad Presentation Protocol and an Ad Click Protocol.

In one embodiment, the Ad Presentation Protocol commences when a device configured to use a browser communicates with a content server. If the browser has communicated with the server previously the device will have encrypted data, containing information about the past interactions between the content server and the browser, and an unencrypted identifier stored in its memory. The browser transmits these items to the content server along with the request.

The content server receives the request from the browser. If the browser transmitted the encrypted data and an unencrypted identifier, the content server uses the unencrypted identifier to look up a key stored in its memory. The server uses the key to decrypt the data and updates the data with additional information about this interaction between the browser and the content server. The content server generates another identifier/key pair, re-encrypts the updated data using the key, and stores the key so that it can be located using the identifier at a later time. The content server transmits the encrypted updated data and the unencrypted new identifier to the browser along with instructions telling the browser to request a web page from the advertiser's web server.

If the browser has not previously transmitted the encrypted data and an unencrypted identifier, then the transaction is treated as a first interaction between the browser and the content server. In this case, the content server creates a new set of data containing information regarding only this interaction between the content server and the browser. The content server generates a new identifier/key pair, uses the new key to encrypt the data, and stores the new key so that it can be located using the new identifier at a later time. The content server transmits the encrypted new data and the unencrypted new identifier to the browser, along with instructions telling the browser to request a web page from the advertiser's web server.

In addition, as part of the Ad Presentation Protocol, the content server prepares a receipt for the advertiser. This receipt contains information that the advertiser uses to determine the legitimacy of a user click on its advertisements in real time. The content server compiles the information for the receipt using the data which it extracts from the encrypted data and, in some embodiments, from data that is the stored in the content server's memory. The content server stores the receipt in its memory along with a unique identifier.

The advertiser receives the identifier for the receipt and subsequently contacts the content server and requests the receipt using the identifier. The content server locates the receipt that is associated with the identifier and transmits the receipt to the advertiser. The receipt is parsed and the advertiser analyzes the data provided by the content server, as described below, to determine whether the click on the advertisement was legitimate. If the advertiser determines that the click is legitimate, it can notify the content server immediately. In addition, in response to the request, the advertiser transmits a response to the browser containing an HTML encoded web page containing advertisements.

Alternatively, the content server can contact the advertiser directly rather than through the browser.

The Ad Click Protocol commences when a user of a device configured to use a browser clicks on a linked advertisement and the browser transmits a request to the content server. This request contains the encrypted data, which includes information regarding the past interactions between the content server and the browser, and the unencrypted identifier.

The content server receives the request from the browser and uses the unencrypted identifier to look up a key stored in its memory. The content server uses the key to decrypt the data and updates the data with additional information about this interaction between the browser and the content server. The content server generates a new identifier/key pair, re-encrypts the updated data using the new key, and stores the new key so that it can be located using the identifier at a later time. The old identifier/key pair may be deleted from the content server's memory.

The content server transmits a response to the browser. This response contains the encrypted data and the unencrypted identifier, the unique identifier for the receipt, and instructions for the browser.

The browser receives the response and stores the encrypted data and unencrypted identifier into the memory of the device. The browser sends a request to the advertiser, forwarding the instructions and the identifier for the receipt.

In one embodiment, the invention is a method of soliciting and receiving a bid for placement of an ad on a web browser. The method includes receiving a request from the browser to serve an ad, the request from the browser including information describing browsing activity of the browser. The method also includes soliciting a bid from the at least one advertiser for placement of an ad on the browser; receiving at least one bid from the at least one advertiser for placement of an ad on the browser; evaluating the at least one bid; and placing an ad from at least one advertiser on the browser based on the evaluation of the at least one bid.

In one embodiment, the invention is a method of transferring information between a first computer and a second computer. The first computer is configured to store linked advertisements and to transmit linked advertisements to at least one client device. The method includes the first computer receiving a mutating cookie from the client device, wherein the mutating cookie comprises encrypted information; receiving the first request and mutating cookie on the first computer; decrypting the encrypted information included in the mutating cookie on the first computer to create unencrypted data; generating a receipt comprising information pertaining to at least one of the client device, the first computer, and the unencrypted data; transferring the receipt to the second computer; and the second computer analyzing the receipt and determining the value of an advertisement delivered to the client device.

In another embodiment, the invention is a method of determining the legitimacy of the selection of a linked advertisement. The method includes transmitting a cookie from a user agent to a content server; updating information in the cookie at the content server; generating a receipt configured for an advertiser, the receipt including information pertaining to activity of a user who selects a linked advertisement; analyzing the receipt; and generating a bid based on the analysis of the receipt.

### BRIEF DESCRIPTION OF THE DRAWINGS

In the drawings:

FIG. 1 schematically illustrates a system for discerning the intent of clicks on a linked advertisement according to one embodiment of the invention.

FIG. 2 schematically illustrates one implementation of the Ad Presentation Protocol by the system of FIG. 1.

FIG. 3 depicts a lookup table used during the protocols described in FIGS. 2 and 5.

FIG. 4A depicts the contents of one type of mutating cookie that can be used in the protocols of FIGS. 2 and 5.

FIG. 4B depicts the contents of another type of mutating cookie that can be used in the protocols of FIGS. 2 and 5.

FIG. 5 schematically illustrates one implementation of the Ad Click Protocol.

FIG. 6 schematically illustrates an alternative of the Ad Click Protocol.

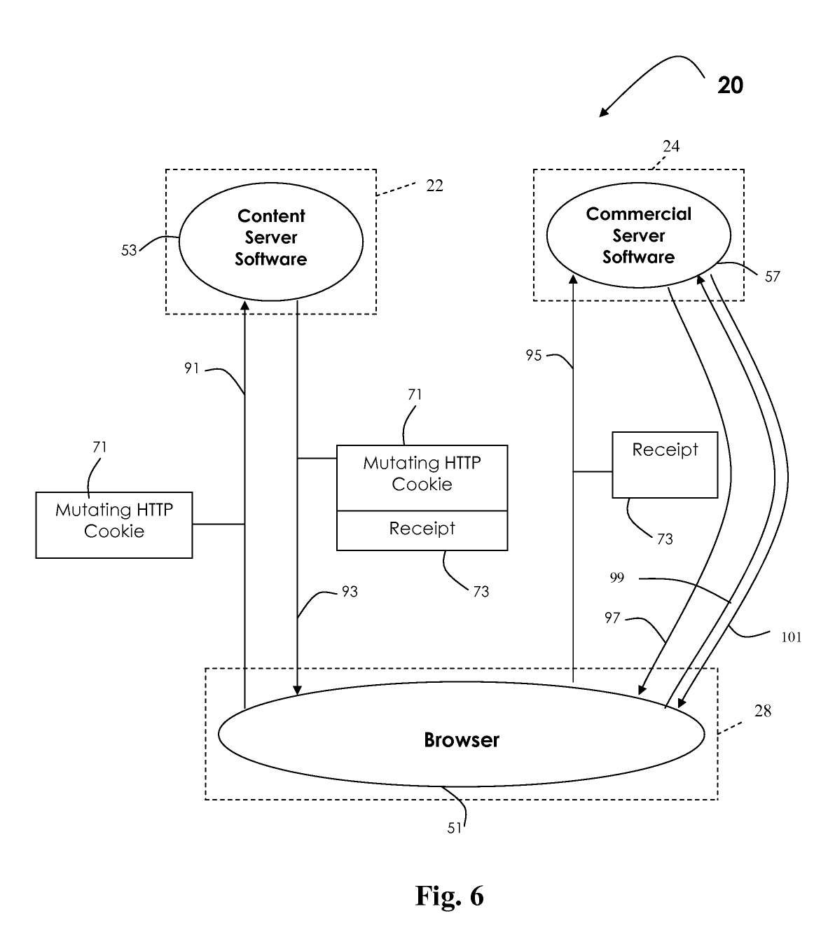

### DETAILED DESCRIPTION

Before embodiments of the invention are explained in detail, it is to be understood that the invention is not limited in its application to the details of the construction and the arrangements of the components set forth in the following description or illustrated in the drawings. The invention is capable of still other embodiments and of being practiced or being carried out in various ways.

In particular, it should be understood that some embodiments are implemented using various computer devices, such as personal or home computers, servers, and other devices that have processors or that are capable of executing programs or sets of instructions, including special-purpose devices, such as cell phones and PDA's. In general, some embodiments may be implemented using existing hardware or hardware that could be readily created by those of ordinary skill in the art. Thus, the architecture of exemplary devices will not be explained in detail, except to note that the devices will generally have a processor, memory (of some kind), and input and output mechanisms. In some cases, the devices may also have one or more operating systems and one or more application programs that are managed by the operating systems. In some embodiments, the hardware devices or software executed by the hardware devices also provides some ability, depending on the role of the device in the particular embodiment of the invention implemented, to encrypt data or decrypt encrypted data. A decryption capability may be provided using a decryption hardware or software module capable of decrypting data that is encrypted using a particular encryption algorithm.

Other embodiments of the invention can be implemented in a distributed environment where individual computers, or network peers, can select advertisements and obtain agreements independently. The independent nature of each transaction lends itself to using distributed computing environments to select advertisements, obtain permission to display these advertisements, and serve these advertisements. In environments like these, many computers may perform the same or similar tasks independent of each other without rigorous coordination from a centralized server.

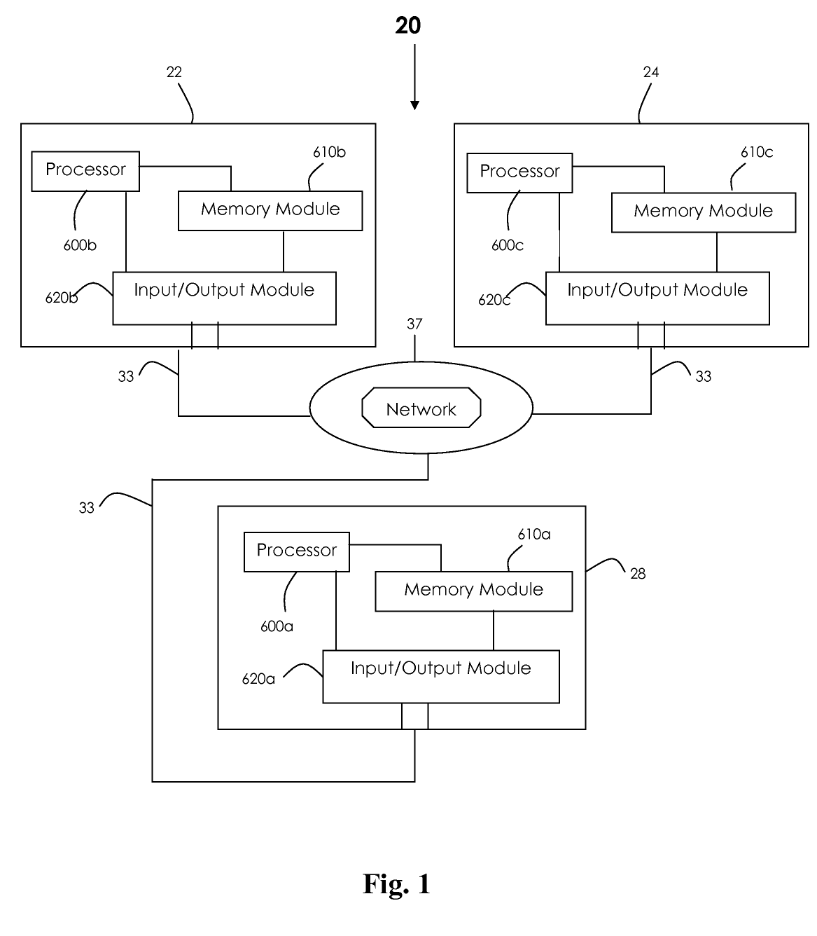

FIG. 1 is a schematic view of the system 20, which is configured to discern the intent of the user of a user device 28 who requests additional information, such as an HTML encoded web page, about an advertiser by, for example, selecting or clicking (using a mouse of other user input device) on the advertiser's linked advertisement. In reality, one or more networks or communication systems, such as a private network (i.e., an intranet), the Internet, the telephone system, wireless networks, satellite networks, cable TV networks, and various other private and public networks and systems, could be used in various combinations to provide the communication links desired or needed to create embodiments or implementations of the invention, as would be apparent to one of ordinary skill in the art. Thus, the invention is not limited to any specific network or combinations of networks. Data can be transferred from one entity to another with wired communications and/or wireless communications or other physical media being carried from one entity to another.

Further, while the exemplary embodiments herein are presented with reference to content comprising advertisements, the disclosed methods and systems can also be employed to track and document users' selections of other types of content, including but not limited to news, weather, entertainment, games, mapping, music downloads, video downloads, and other types of content.

As shown in FIG. 1, the system 20 includes a user device 28, a content server 22 (which stores linked advertisements and optionally, other content), and an advertiser, or commercial, server 24 (that stores an advertiser's web content). In other embodiments of the invention, the system 20 may include fewer or additional devices, by for example, combining the content server 22 and the advertiser server 24 on the same device. Each device includes a processor 600 (e.g., 600a, 600b, and 600c), a memory module 610 (e.g., 610a, 610b, and 610c), and an input/output module 620 (e.g., 620a, 620b, and 620c). It should be understood that the components shown in FIG. 1 are exemplary and can be combined and distributed in various arrangements and configurations. For example, a memory module 610 can be included in a processor 600 and/or an input/output module 620 in place of or in addition to being included as a separate component. The input/output modules 610 can also be located in an apparatus external to the device housing the corresponding processor 600.

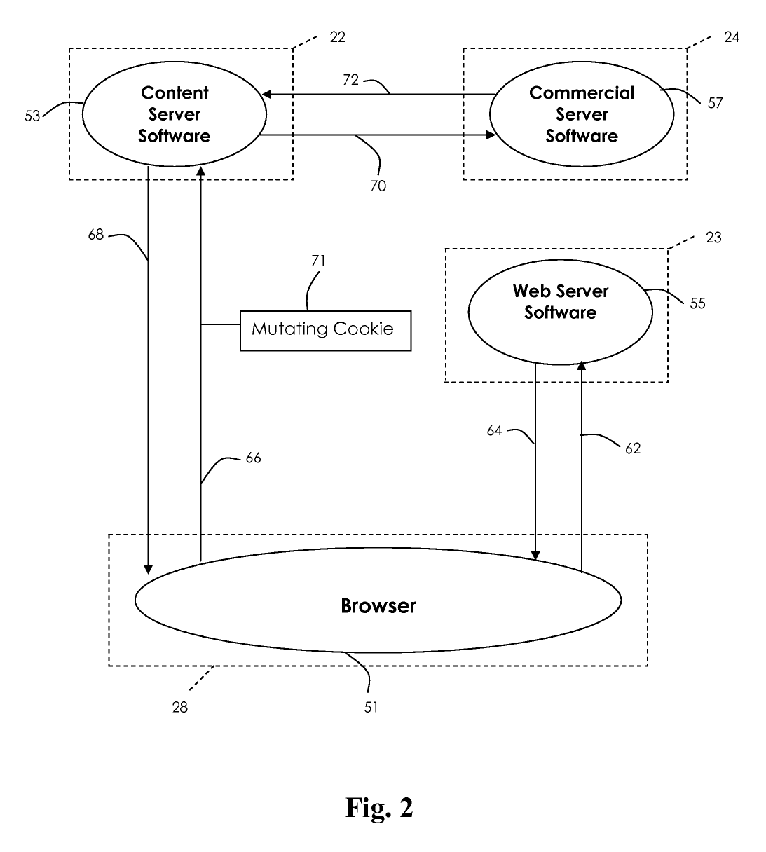

The processor 600 can include one or more processors or similar circuitry. The memory modules 610 store instructions and data retrieved and executed by the processor 600. The functions performed by each processor 600, and consequently the instructions and data stored in the memory module 610 of each device, can be configured based on the role a particular device plays in performing a transaction. In one embodiment, the user device 28 is configured to run some sort of user agent or software that permits a user to access information, such as a browser 51, capable of communicating with other devices configured to run an HTTP server over a computer network, as described below and illustrated in FIG. 2. In this embodiment, the processor 600a on the user device 28 is capable of executing the functions performed by the browser 51 and the memory module 610a stores the instructions and data used by the processor 600a. In addition, the content server 22 and the advertiser server 24 are both configured to run HTTP servers, capable of receiving and responding to requests from a device configured to run an HTTP client, such as a browser 51, over a computer network, as described below and illustrated in FIG. 2. In this embodiment, the processors 600b, 600c on the content server 22 and the advertiser server 24 are capable of executing the functions performed by an HTTP server and the memory modules 610b, 610c store the instructions and data used by the processors 600b, 600c. It should be noted however that the invention may also be used with other computer applications and computer network protocols such as UDP or TCP/IP. In addition,

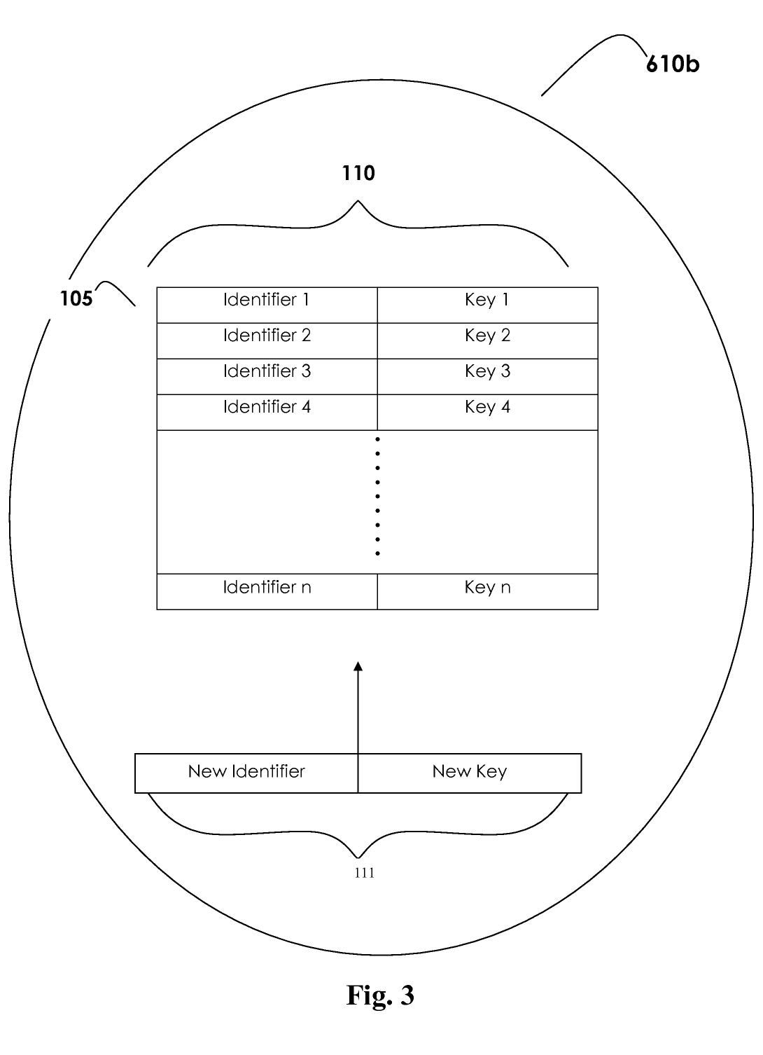

In addition to storing the instructions and data used by the processors 600, the memory modules 610 can also store data received or transmitted by a particular device via its input/output module 620. For example, in one embodiment the memory module 610a stores at least one HTTP cookie which is associated with the content server 22 and which contains encrypted data concerning the history of interactions between the user device 28 and the content server 22, and an unencrypted identifier. The encrypted data concerning the history of interactions can be analyzed to produce the various Metrics, as discussed below. Further, the memory modules 610b, 610c for the content server 22 and advertiser server 24 may store at least one identifier/key pair used by the processors 600b, 600c to encrypt and decrypt data as described below with respect to FIGS. 2 and 3.

As shown in FIG. 1, each device includes an input/output module 620 that interfaces with at least one communication link 33. It should be understood that although the devices as shown are connected to each other by a single, direct connection, the devices may be connected via one or more wired or wireless connections over one or more networks 37 or communication systems. Each input/output module 620 can also interface with additional devices over the same or additional communication links.

As directed by a processor 600, each input/output module 620 can output data to another device. Similarly, each input/output module 620 can receive data from another device and forward the data to the associated processor 600 and/or memory module 610. As noted above, the input/output module 620 of a particular apparatus can be located external to the apparatus housing the processor 600 and/or the memory module 610.

In general, the content server software 53 generates data that will be used in the evaluation of the transactional history of a browser 51 to determine the value of the advertisement on the browser 51. The evaluation is based on one or more sources of information, including information stored on the user device 28 associated with the browser 51, for example in the form of a cookie. The content server 22 may also include storage space to track additional information associated with each cookie, since the cookies are limited in how much information they can contain.

The content server software 53 can also include functions that allow the advertisers to set or change parameters such as those discussed herein, for example to set the numerical or other values associated with various metrics. In one embodiment the functions are implemented on the content server 22 through a web interface accessible from the advertiser's browser. In one embodiment the advertiser accesses the web interface through a secure connection, e.g. using a PKI certificate. The functions may be integrated into the content server software 53, or may be a separate software component on the content server 22, or the functions may be stored and executed from a different hardware platform altogether.

In one embodiment, the advertiser maintains its own independent proxy server that includes the various metrics and tools and uses these to evaluate whether to agree to display an ad on a particular browser. The advertiser's proxy server or the content server 22 may include a log of information representing a compilation of ad clicking history obtained from the various browsers' cookies. The metrics and tools on the proxy server can use the information in the log when evaluating whether to accept placement of an ad on the browser.

Generally, the cookies that are associated with a browser are so-called “persistent cookies” which include an expiration date. The cookie expiration date can be set for any length of time into the future, for example any number of minutes, hours, days, weeks, months, years, etc. from the date the cookie is created or last modified. Without an expiration date the cookies are typically deleted by the operating system or browser as soon as the browser program is closed.

Thus, in one embodiment the advertiser maintains its own server that manages the metrics and other protocols that are used to predict whether to place an on a particular browser. The content server software 53 delivers to the advertiser's server any information needed to perform the protocols, including for example the recent ad presentation and ad clicking activity of the browser in question. In one particular embodiment in which the advertiser maintains its own server, the advertiser's server can communicate with the content server 22 through the network 37, so that the advertiser's server can give approval for placing each ad. To prevent the content server 22 from having to wait too long for a response from the advertiser's server regarding whether to run the ad, a timeout duration can be set, e.g. 100 milliseconds. If the content server 22 does not receive a response from the advertiser's server regarding whether to run a particular ad before the timeout period expires, then the content server 22 will run a different ad on the browser 51.

In other embodiments, the metrics and other protocols are run on the content server 22 but are effectively under the control of the advertiser via a web-based settings menu that is run from the content server 22. In either case, the advertiser maintains control over which of its ads are placed on browsers, albeit indirectly by setting parameters. Further, in various embodiments the metrics and other protocols can be applied to all of the ads for a particular advertiser, some subgroup of ads, or each ad individually. Finally, by separately tracking which ad has been shown to which browser, it is possible for an advertiser to present groups of ads to a browser in a sequential manner to effect a graded ad campaign or to “tell a story” through the presentation of ads in a particular sequence.

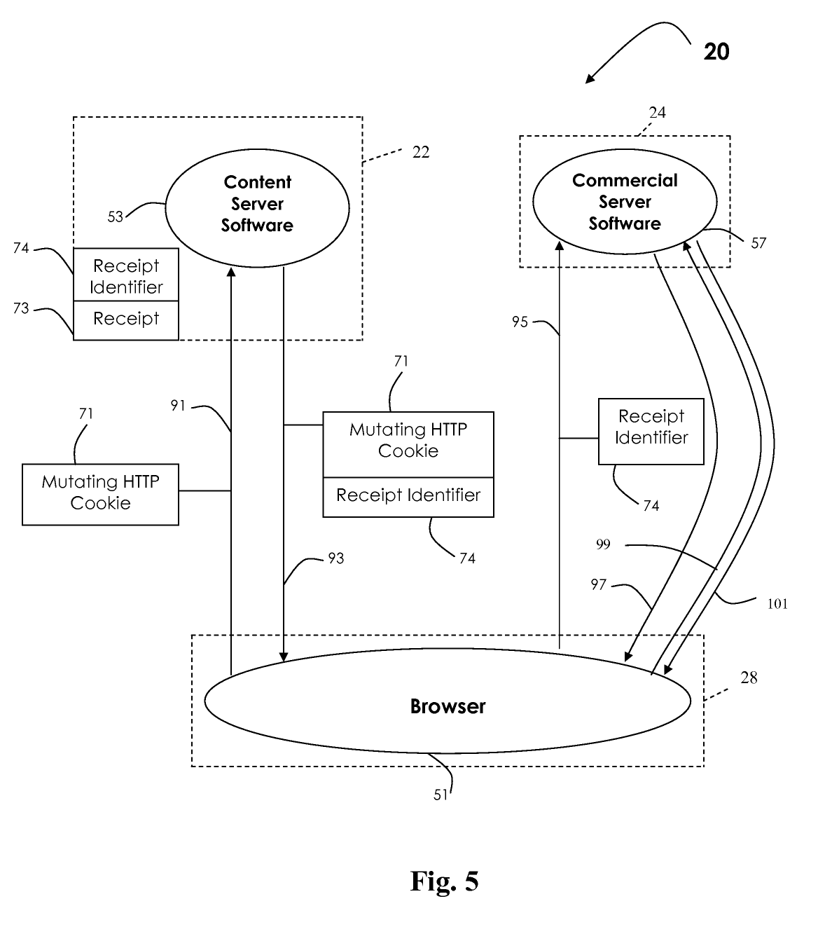

The system 20 utilizes two protocols: an Ad Presentation Protocol and an Ad Click Protocol. These protocols, which are described below, are used to gather information which can then be analyzed to infer the intent of a user who clicks on a linked advertisement. As shown in FIGS. 2 and 5 and described in greater detail below, the Ad Presentation Protocol and the Ad Click Protocol are implemented by a browser (B) 51, content server software (S) 53, web server software (C) 55 (FIG. 2), and commercial server software (A) 57 running on the advertiser, or commercial, server 24 (FIG. 5). The following table, Table 1, is a list of other symbols used in this document to explain the illustrated embodiments of the proposed protocols.

TABLE 1

| Symbol | Meaning |
|---|---|
| P | Data (e.g., information regarding or summarizing the |
| | history of interactions between two devices). |
| K_{X} | A key for a symmetric cipher. |
| N_{X} | A one-use identifier associated with some key K_{X}. |
| E(K_{X}, W) | A cipher E that encrypts W with a key K_{X}. |
| X → Y: Z | A message Z sent from X to Y. |
| CK(X) | Information X which has been placed inside of an HTTP |
| | cookie CK. |

### Ad Presentation Protocol

FIG. 2 is a schematic representation of the Ad Presentation Protocol. In one embodiment, the Ad Presentation Protocol is implemented by a browser 51; content server software 53, which resides on the content server 22; and web server software 55, which may reside on a Third-Party Web Server 23. The Ad Presentation Protocol is implemented by the system 20 each time that the browser 51 transmits a request 62 to the web server software 55. In the illustrated embodiment, the Ad Presentation Protocol includes the steps shown in Table 2 and described in detail below:

TABLE 2

| | |
|---|---|
| 1. B → C | The browser 51 requests information, such as an encoded web page, from the |
| | web server software 55. |
| 2. C → B | The web server software 55 transmits the requested information, for example an |
| | encoded web page, to the browser 51. Within the encoded web page are |
| | instructions to tell the browser 51 to retrieve linked advertisements from the |
| | content server software 53. |
| 3. B → S | The browser 51 sends a request to the content server software 53. This request |
| | includes the fact that the browser 51 requested a document from the web server |
| | software 55 and may include other information, including encrypted data with |
| | information regarding the browser's 51 past advertisement clicking behavior. |
| 4. S → A | The content server software 53 sends a request to the commercial server software |
| | 57, the request containing details collected about the browser 51. |
| 5. A → S | The commercial server software 57 evaluates the browser 51 and determines the |
| | value of the browser 51. This value is returned to the content server software 53. |
| 6. S → B | The content server software 53 parses this information and returns appropriate |
| | ads and other information, including updated encrypted data regarding the |
| | browser's 51 past advertisement clicking behavior. |

In one particular embodiment of the Ad Presentation Protocol, the system 20 is used to implement a method to solicit and receive bids for placement of advertisements on the browser 51. In the method, the content server software 53 receives a request from the browser 51 to serve an ad, where the request from the browser 51 includes information describing past browsing activity of the browser 51. The content server software then initiates a bidding process in which one or more advertisers bid for placement of their ads on the browser 51. The content server software 53 forwards the information describing the browsing activity of the browser 51 to at least one advertiser's commercial server software 57 and solicits a bid from the at least one advertiser for placement of an ad on the browser 51. The advertiser's commercial server software 57 evaluates the quality of the browser 51, based on the advertiser's metrics, and based on this evaluation the advertiser determines whether and how much it will bid for placement of an ad on the browser 51. The advertiser's commercial server software 57 then transmits the bid back to the content server software 53. The content server software 53 collects the bids from the at least one advertiser and evaluates the bids. The content server software 53 evaluates bids for example by sorting them from the highest to lowest and also factors in conditions placed on the bid, where present, such as how prominently the ad is placed within the browser 51. After evaluating and sorting the bids, the content server software 53 places one or more ads on the browser 51.

A bid may consist of no bid, meaning that the advertiser does not want to place an ad on the browser 51. Alternatively, the advertiser may place a bid for the normal or standard advertising rate, or some increase or decrease from the normal or standard rate. The deviation from the standard rate may be represented in a number of ways, for example as a fraction or multiplier to be applied to the standard rate, or as a fixed amount to be added to or subtracted from the standard rate. Furthermore, in some embodiments the advertiser may place additional conditions on the bid, for example setting different bid values based on how prominently the ad is placed within the browser 51, offering a higher bid for premium placement within the browser 51 and progressively lower bids for less prominent placements. In general, the advertiser does not know how many other advertisers are participating in the auction and so is always motivated to present their highest bid.

In some embodiments, the content server software 53 solicits and receives bids internally by performing the calculation of each advertiser's bid based on criteria supplied by the respective advertisers, without actually transmitting the browser information to the advertisers. In these embodiments the content server software 53 conducts the advertising ‘auction’ internally for each ad placement. The advertisers can adjust their browser-evaluation parameters on the content server software 53 to increase or decrease their advertising budget and to adjust the level of quality of ad placement they receive.

In certain embodiments, the request from the browser 51 includes a cookie which contains the information describing the past browsing activity of the browser 51. In some embodiments the cookie is a mutating cookie. In still other embodiments, the information about the browser's 51 activity is maintained by the content server software 53, for example as a web log of the browser's 51 activity.

According to the particular embodiment of the invention shown in Table 2, the first step of the Ad Presentation Protocol is initiated when the browser 51, in response to the actions of the user, transmits a request (Req₆₂) 62 to the web server software 55, requesting information, such as an encoded web page, as described above and depicted in FIG. 2.
B→C: Req₆₂

During the second step of the protocol, the web server software 55 transmits a response (Resp₆₄) 64 to the browser 51 containing the requested information, such as an encoded web page. It should be understood that the web page may be encoded using HTML, XML, XHTML, or any other language or protocol suitable for encoding information on the Internet. Within the encoded web page are instructions that tell the browser 51 to request linked advertisements from the content server 22. In one embodiment of the invention, these linked advertisements are interactive in nature such that a user can select them, using a mouse or other user input device, to view web content of an advertiser.
C→B: Resp₆₄

During the third step of the Ad Presentation Protocol, the browser 51 sends a request (Req₆₆) 66 to the content server software 53. This request notifies the content server software 53 that the browser 51 requested a web page from the web server software 55 and may include other information stored in cookies which are associated with the content server software 53. The first stage of this third step of the Ad Presentation Protocol is carried out in two ways, depending on whether the user device 28 has encrypted data, containing information about the prior interactions between the browser 51 and the content server software 53, and an unencrypted identifier stored on its memory module 610a. Both the encrypted data and the unencrypted identifier are discussed in detail below.

If the user device 28 does not have the encrypted data and the unencrypted identifier stored in its memory module 610a, then the browser 51 transmits only the request 66 to the content server software 53.
B→S: Req₆₆
   The content server software 53 parses the information transmitted by the browser 51 as part of the request 66, including any cookies transmitted by the browser 51. The content server software 53 generates new data (P_{new}) containing information regarding the current interaction between the browser 51 and the content server software 53. Some examples of the types of information contained in this new data are discussed below. The content server software 53 also generates an identifier (N_{new}) and a key (K_{new}) and uses a symmetric encryption algorithm (E) to encrypt the new data using K_{new} as a key (E(K_{new}, P_{new})).

The content server software 53 stores the identifier/key pair (K_{New}/N_{New}) on the memory module 610b of the content server 22. As shown in FIG. 3, in one embodiment of the invention, the identifier/key pairs (Nx/Kx) 110 that are generated by the content server software 53 may be stored in a lookup table 105. The lookup table 105 stores a number of identifier/key pairs 110 and is configured such that any key Kx may be located in the table by using the corresponding identifier Nx. In other embodiments, these identifier/key pairs may be stored in a data structure that enables the content server software 53 to quickly locate a key Kx which corresponds to a given identifier Nx.

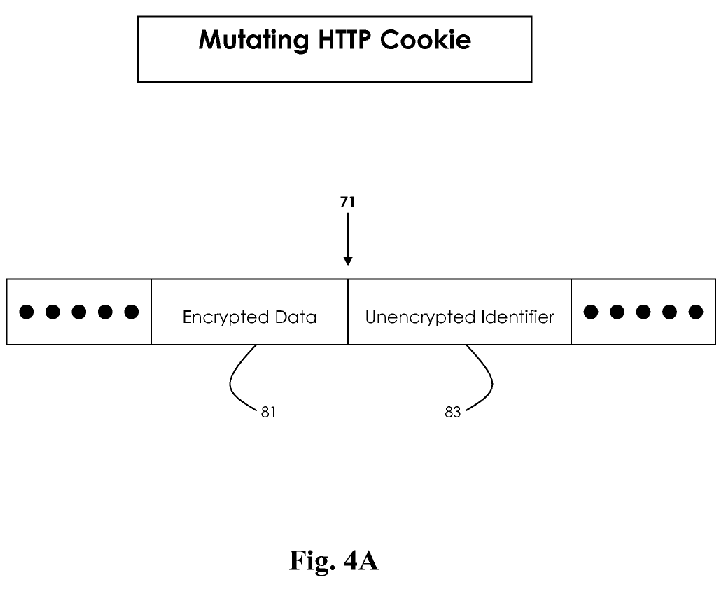

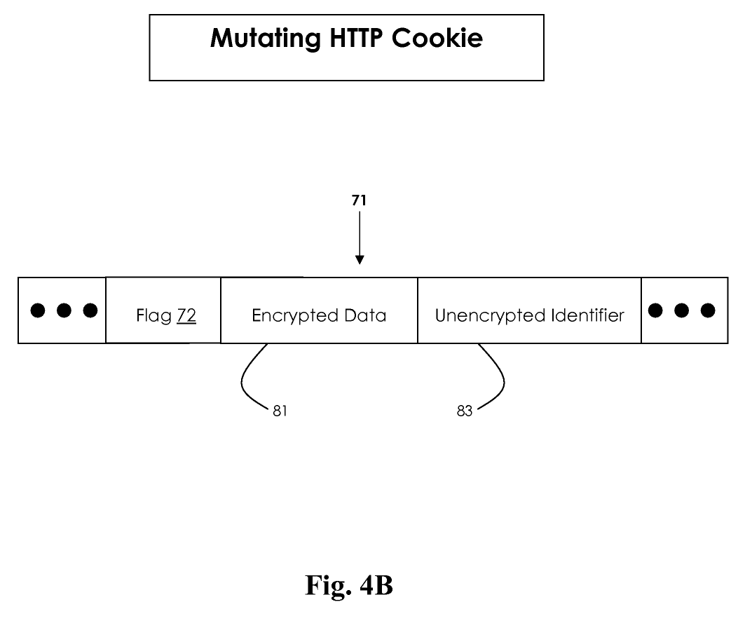

Alternatively, if the user device 28 has encrypted data (E(K_{old}, P_{old})), containing information about previous interactions between the browser 51 and the content server software 53, and an unencrypted identifier (N_{old}) stored in its memory module 610a when the browser 51 sends the request 66, the browser 61 sends both of these items along with the request 66. In one embodiment, the encrypted data and the unencrypted identifier are stored in the form of a mutating cookie 71. FIGS. 4A and 4B are representations of two possible types of mutating cookies 71. The mutating cookie 71 includes encrypted data 81 and an unencrypted identifier 83. In this embodiment, the mutating cookie 71 is transmitted with the request 66.
B→S: Req₆₆, CK(N_{old}, E(K_{old}, P_{old}))

The content server software 53 parses the request 66 and the mutating cookie 71. The content server software 53 extracts the unencrypted identifier 83 from the mutating cookie 71 and uses it to locate a key (K_{old}) stored in the lookup table 105. The content server software 53 extracts the encrypted data 81 from the mutating cookie 71 and decrypts the data 81 using the key. The content server software 53 generates updated data (P_{new}) containing information about this interaction and previous interactions between the browser 51 and the content server software 53 in the manner described below. In addition, the content server software 53 generates a new identifier/key pair (N_{new}/K_{new}) and uses the new key to encrypt the updated data (E(K_{new}, P_{new})). The new identifier/key pair 111 is stored in the lookup table 105 and the old identifier/key (K_{old}/N_{old}) is deleted from the lookup table or marked as used, so that each identifier and key are only used one time.

The mutating cookie 71 may contain a number of different fields pertaining to the state information of the browser. Included among the possible fields in the mutating cookie 71 are: a unique identifier for the browser 51; the time of day that the mutating cookie 71 was placed on the browser 51 (or the time the mutating cookie 71 was sent to the browser 51); the time that the browser 51 spent viewing one or more ads; the respective times of the browser's 51 last ten ad clicks; the respective times of the last ten ad loads onto the browser 51; the Internet Protocol (IP) address of the browser 51; information describing a plurality of previous clicks (e.g. the previous thirty-two clicks), such as the domain, the URL, a context or keyword, and the time of day of each click; an indicator of whether or not the browser is in Sandbox Mode (using flag 72, discussed further below) and may also include the address of the web site that is in Sandbox Mode; the address of the referring site, i.e. the site the ad will be placed on; the price for placing a selected ad; and the price for clicking on the selected ad. Some or all of the information stored in the mutating cookie 71 may be stored as hash values, or hashes, produced from the text. In one embodiment, a mutating cookie 71 that includes at least one of the above fields is referred to as a receipt 73 (discussed further below).

During the final stage of this third step in the Ad Presentation Protocol, the content server software 53 generates a new mutating cookie 71 which contains the new or updated encrypted data and, in some embodiments, the unencrypted new identifier. The content server software 53 also selects the advertisement to be linked and displayed on the web page that the user is viewing. The selection of the advertisement to be displayed may depend on the subject matter of the web page where the advertisement will be viewed and/or on one or more characteristics of the browser 51. Depending on these characteristics, the content server software 53 will select advertisements that increase its revenues and decrease the risk of malicious advertisement clicking behavior. For example, the content server software 53 may determine that the browser 51 is likely to be of malicious intent by using one or more of the metrics described below. If the browser 51 is likely to be of malicious intent then the content server software 53 can select an alternative advertisement that is less vulnerable to the behavior. Alternatively, the content server software 53 may deliver the advertisement to the browser 51 but not charge the advertiser for the display or subsequent click on the ad, if any. Thus, no indication is generally given to the user of the browser 51 that it has been identified as suspicious. This impedes the ability of the malicious user to easily learn the types of behavior and the thresholds that the content server software 53 is using to identify suspicious behavior, and adjust its behavior accordingly. Preferably, the choice of alternative advertisement is one that is consistent with the type of advertisement that would be expected on the web page.

The fourth (S→A, 70) and fifth (A→S, 72) steps allow the content server software 53 to communicate the various browser metrics to one or more advertiser, or commercial, servers 24 and for the commercial server software 57 to indicate the value of the browser 51. The one or more commercial servers 24 engage in a silent auction for placement of advertisements delivered by the content server to the browser in the next step. In some embodiments, the commercial servers 24 will indicate their willingness to increase their bid by a fixed multiple or amount. In other embodiments, the commercial servers 24 will respond with a premium amount they are willing to pay. In yet other embodiments, the commercial servers 24 will respond with an actual bid for the browsers 51.

Finally, the content server software 53 transmits a response 68 to the browser 51 containing the encoded linked advertisements in a precise arrangement determined by the silent auction described in the previous paragraph. These advertisements will be displayed on the web page that the user is viewing. In addition, the content server software 53 transmits the new mutating cookie 71 to the browser 51 along with the response 68.
S→B: Resp₆₈, CK(N_{new}, E(K_{new}, P_{new}))

The browser 51 receives the response 68, stores any HTTP cookies sent as part of the response 58, including the mutating cookie 71, in the memory module 610a of the user device, and displays the linked advertisement on the web page.

In some embodiments, the web server software 55 is the content server software 53 and steps 1 and 2 can be omitted.

It should be understood with respect to the Ad Presentation Protocol that in alternative embodiments, non-mutating cookies may be used. That is, the content server software 53 may reuse the same identifiers or even the same keys when encrypting the updated data, such that it is unnecessary to generate a new identifier and/or new key for each instance of the Ad Presentation Protocol. Further, additional embodiments may not require the creation and use of any identifiers by the content server software 53. In such an embodiment, when the content server software 53 receives encrypted data from a browser 51, it will try to decrypt it using one of the keys stored in the memory module 610b of the content server 22. The content server software 53 may attempt to decrypt the encrypted data using the key that was stored in the content server's 22 memory module 610b most recently. If that key successfully decrypts the encrypted data, then the decryption process ends. If the key is not successful, then the content server software 53 may attempt a number of the other keys that were most recently stored in the memory module 610b of the content server 22. If any one of those keys successfully decrypts the encrypted data, then the decryption process ends. If none of those keys is successful, which may indicate that the encrypted data is old and no longer relevant, then the decryption process is unsuccessful and the encrypted data is discarded.

In still other embodiments, the system 20 may maintain a counter whose value is returned to the browser 51 at the end of each transaction. The counter value sent to each browser may be stored in a number of locations, for example on the content server 22, on the advertiser's proxy server, or any other suitable location. The counter value may be incremented each time a new ad is served or the counter value may simply be a random number. When a request for an ad is received from a browser 51, the value of the counter that is included with the request is compared to at least one of the counter value that was previously received from the same browser 51 and the counter value that was previously sent to the browser 51. If the counter value received from the browser 51 is the same for two requests, it indicates that the second request is not ‘fresh,’ which may indicate that the browser 51 is re-sending the same information with the request, possibly in an effort to avoid detection of its ad-viewing or ad-clicking activity. Similarly, if the counter value that is received along with the request from the browser 51 is not the same as the value that was most recently sent to the browser 51 as part of the previous transaction, this may also indicate that the browser 51 is sending incorrect information along with the request, possibly to avoid detection of its activities. The counter value may be exchanged between the browser 51 and a server using a cookie, or alternatively using an HTML GET or POST command.

Although many exemplary embodiments presented herein utilize encrypted information in the cookies, in other embodiments the inventive methods can be performed without encryption. In one embodiment, each cookie is a random number, which is chosen by a server such as the content server or proxy server and which changes with each advertisement load and/or click. This random number can serve as an index into a database stored at the advertiser's proxy server or other server, where the database stores the past browsing habits of the browser 51. In one particular embodiment, when presented with the random number, the server looks up the browsing habits in the database, updates the information pertaining to the browsing habits, sends the browsing habits information to the proxy server, and awaits the response. In some embodiments, once the random number has been used once, it is marked as such or deleted.

In an alternative embodiment, a “fresh” (i.e. not previously used) and unpredictable identifier is included with client requests and server responses to refer to state information held by the server. The following approach requires 2n storage where n is the size of non-stale “clients”. This approach has the advantage that no keys (or cryptography) are used and hence there is no need to account for keys that “expire”. Also, this approach has the property that it is tolerant to a threshold of failures while maintaining historical information (i.e. due to a communication failure need not start from scratch and treat a client as a new entity). This technique for tolerating a threshold of failures can be extended to other methods. Upon receipt of a request with an invalid (or non-existent) state information, assign the “new” browser a number Cᵢ. Preferably, the number Cᵢ is a random number chosen from a large space so that it is highly unlikely an adversary able to predict a valid Cᵢ. Preferably, the computer has a hardware random number generator for generating random numbers. Alternatively, lists of random numbers can be supplied to the server. The server sends back Rⱼ (and optionally Cᵢ if the browser is unable to maintain Cᵢ for the next request) where Rⱼ is the current “state” associated with the browser. The server stores (Cᵢ, Rⱼ, Null, Counter=0). Upon receipt of (Cᵢ, Rⱼ) the server sends back (Cᵢ, Rⱼ₊₁) and updates the state (Cᵢ, Rⱼ, Rⱼ₊₁, Counter=0}. Computers or communications might fail. Thus, the server associates a counter, “Counter”, with each client. The counter indicates the number of times a request has been received using the immediately prior state Rⱼ. Preferably, the server allows at most one replay of Rⱼ. As an optional extension, the server maintains a window counter, e.g. which might be called “Window_Counter”, which tracks the number of times replayed state has been received for Cᵢ over some window of time e.g. one month. If the window counter exceeds a threshold then the server operates according to the defined policy. A number of policies can be defined. One policy is to act substantially the same as if the threshold was not exceeded with the exception of changing the payment associated with the click through. The change of payment can be performed in several ways. At the billing cycle the advertiser can be provided with a credit for some number of clicks without being told exactly which requests were associated with the credit. Alternatively, at any point in time one or more parties to the transaction can be told about the charging for the particular click through. This may expose the detection of the fraudulent click-throughs but provides transparency to the parties in the transaction.

In another alternative embodiment, state information can be tracked without receiving a (plaintext) client identifier. The previous approach can be used without using the index Cᵢ associated with the client. This assumes that the random numbers are sufficiently large that it is highly unlikely that an adversary could guess a random number associated with a current or prior state of a client. Preferably, the computer uses associative memory to correlate the random number with an internal customer index used to retrieve the customer's information.

In still another alternative embodiment, state information can be tracked by encrypting the Cᵢ such that anyone other than the server would be unable to determine the particular Cᵢ in the request or response. For example, the transmission of “Cᵢ” in the first embodiment can be substituted with “q, x_p, E(K_{q}, Cᵢ XOR xₚ) where q identifies which key used by the server to encrypt the client identifier Cᵢ, x_p is a fresh random number for each time Cᵢ is encrypted, and enc( ) is block encryption using the key as the first parameter and data to be encrypted as the second parameter. Servers might employ arbitrarily many keys to encrypt client identifiers. Furthermore, the keys can be updated over time by providing a new key identifier and new encryption in a server response. That is keys can be used to decrypt old state identifiers and new keys used to encrypt new state identifiers. When the encryption keys change and a client request is received, it is preferable to generate a new client identifier (Cᵢ′) and associate the new client identifier with the old state information (i.e. Cᵢ state information).

### Ad Click Protocol

FIG. 5 is a schematic representation of the Ad Click Protocol. In one embodiment, the Ad Click Protocol is implemented by a browser 51, the content server software 53, and commercial server software 57, which resides on the advertiser server 24. The Ad Click Protocol is implemented by the system 20 each time a user of the user device 28 clicks (using a mouse or other user input device) on a linked advertisement. In the illustrated embodiment, the Ad Click Protocol includes the steps shown in Table 3 and described below:

TABLE 3

| | |
|---|---|
| 1. B → S | The user clicks on a linked advertisement which instructs the browser to send a |
| | request to the content server software. Other information may also be transmitted |
| | in this message as cookies. In addition, the browser sends the mutating cookie as |
| | part of this transmission. |
| 2. S → B | The content server software returns a response to the browser. This response |
| | includes instructions for the browser, the mutating cookie, and a receipt identifier |
| | or an encrypted receipt. |

During the first step of the Ad Click Protocol the user clicks on a linked advertisement (using a mouse or other input device) and the browser 51 transmits a request (Req₉₁) 91 to the content server software 53. The request 91 notifies the content server software 53 that a linked advertisement has been selected on the browser 51, and contains information regarding the linked advertisement that was selected, the referring web site, and additional information, some of which may be stored in HTTP cookies. The request 91 also contains a mutating cookie 71 associated with the content server software 53.
B→S: Req₉₁, H(N_{old}, E(K_{old},P_{old}))

The content server software 53 receives the request 91 and parses the information contained therein. The unencrypted identifier (N_{old}) 83 is extracted from the mutating cookie 71 and is used to locate the corresponding key (K_{old}) in the lookup table 105. The encrypted data (E(K_{old}, P_{old})) 81 is extracted from the mutating cookie 71, decrypted using the key, and updated with additional information (P_{new}) regarding the current interaction between the content server software 53 and the browser 51, as described below. The content server software 53 generates a new identifier/key pair (N_{new}/K_{new}) 111, and uses the new key to encrypt the updated data (E(K_{new}, P_{new})). The content server software 53 stores the new identifier/key pair in the lookup table 105 and deletes the old identifier/key pair from the lookup table 105 or marks the pair as used.

In alternative embodiments, the content server software 53 may reuse the same identifiers or even the same keys when encrypting the updated data, such that it is unnecessary to generate a new identifier and/or new key for each instance of the Ad Click Protocol. Further, additional embodiments may not require the creation and use of any identifiers by the content server software 53. In such an embodiment, decryption of the encrypted data may occur in a similar manner to that described above with respect to alternative embodiments of the Ad Presentation Protocol that do not use identifiers.

### Variable Metric Evaluation

Certain metrics used to evaluate browser fitness and legitimacy involve a binary decision: either a browser is fit or it isn't. For certain embodiments, the commercial server must indicate whether or not a browser merits an agreed-upon premium (for instance, doubling of a bid). However, other embodiments involve the commercial server deriving some value other than yes or no on the fly.

In some embodiments, a metric is a test with a threshold such that if a browser meets or exceeds the threshold in the test, the test indicates the browser is legitimate. So, if the commercial server and content server enter an agreement where the commercial server is asked if a particular browser merits an agreed-upon increase in value, the commercial server can evaluate fitness using a set of metrics. If a browser meets or exceeds the thresholds in some or all of the metrics applied by the commercial server, the commercial server can indicate to the content server the desire to pay more for the browser to improve placement of an advertisement.

In other embodiments, the commercial server must specify a premium or value that has not been agreed upon by either server. In order to do this, the same metrics used above can be repurposed to generate this premium or value. In this way, variable metrics can be developed, producing a test that indicates legitimacy on a sliding scale, with 0 indicating fraud and 1 indicating legitimacy.

In order to do this, each metric must have two thresholds: one that indicates legitimacy and one that indicates fraud. Call these thresholds l and f, respectively. If, upon evaluation, a browser tests below f or above l, the browser is deemed to be fraudulent or legitimate for this metric and so the variable metric would take the value of 0 or 1, respectively. If, on the other hand, the browser's metric is m such that f<m<l, the variable metric would be (m−f)/(l−f).

In these embodiments, the commercial server has chosen a minimum and maximum value to be placed on any browser. The specific value of a particular browser will be determined by a weighted average of these extrema with the weights determined by a weighted average of the metrics used to evaluate fitness. The weights of the second average can be determined a priori by the content server or the commercial server, on the fly by either, or computed by yet another party. Call the value of the second average w. Then, the overall price, premium, or value of the browser can be computed as (1−w)*minimum+w*maximum.

For instance, in one particular embodiment, the data collected about a browser contains information about when the most recent clicks were and when the most recent advertisement presentations were. The standard deviation of the difference in the click times and the standard deviation of the difference in presentation times can be computed. If the standard deviation of the click differences is below some value and the standard deviation of the presentation differences is below another, the browser can be considered fraudulent. Likewise, if the standard deviations are above yet other values, they can be considered legitimate insofar as a fraudulent scheme will often involve automatically generating clicks by a computer at highly-regular intervals that will lead to a very small standard deviation between the lengths of the intervals.

These protocols are used to compute a particular value of a browser with respect to advertisement placement. Once this value is computed by one or several commercial servers, the content server will use this information to determine advertising placement.

What is claimed is:

1. A method of soliciting and receiving a bid for placement of an ad on a web browser, comprising:
receiving a request from the browser to serve an ad, the request from the browser including information describing browsing activity of the browser;
soliciting a bid from the at least one advertiser for placement of an ad on the browser;
receiving at least one bid from the at least one advertiser for placement of an ad on the browser;
evaluating the at least one bid; and
placing an ad from at least one advertiser on the browser based on the evaluation of the at least one bid.

2. The method of claim 1, further comprising, after receiving a request from the browser to serve an ad, forwarding the information describing the browsing activity of the browser to at least one advertiser.

3. The method of claim 1, wherein the bid comprises an increased fee above a standard rate that the advertiser will pay for placement of the ad on the browser.

4. The method of claim 1, wherein a plurality of advertisers submit a plurality of bids and wherein evaluating the bids comprises comparing the values of each of the plurality of bids.

5. The method of claim 4, wherein evaluating the bids further comprises sorting the bids from highest to lowest.

6. The method of claim 1, wherein a bid comprises a value equal to a standard rate for ad placement; a value above a standard rate for ad placement; or no bid.

7. The method of claim 1, wherein the request from the browser to serve an ad comprises a cookie that includes the information describing browsing activity of the browser.

8. The method of claim 7, wherein the cookie is a mutating cookie.

9. A method of transferring information between a first computer and a second computer, the first computer configured to store linked advertisements and to transmit linked advertisements to at least one client device, the method comprising:
the first computer receiving a mutating cookie from the client device, wherein the mutating cookie comprises encrypted information;
receiving the first request and mutating cookie on the first computer;
decrypting the encrypted information included in the mutating cookie on the first computer to create unencrypted data;
generating a receipt comprising information pertaining to at least one of the client device, the first computer, and the unencrypted data;
transferring the receipt to the second computer; and
the second computer analyzing the receipt and determining the value of an advertisement delivered to the client device.

10. The method as claimed in claim 9, further comprising:
generating an identifier on the first computer and associating the identifier with the receipt;
transmitting a first response and the identifier to the client device from the first computer;
receiving a second request and the identifier on the second computer from the client device;
transmitting a third request and the identifier to the first computer from the second computer;
receiving the third request and the identifier on the first computer;
retrieving the receipt from the memory module of the first computer using the identifier; and
transmitting a second response and the receipt to the second computer.

11. The method as claimed in claim 9, wherein generating a receipt includes compiling summary information from the unencrypted data.

12. The method as claimed in claim 11, wherein the summary information comprises a list of times of advertisement presentations and advertisement clicks such that if the standard deviation of the difference these times is above a threshold the browser is deemed legitimate and below a threshold, the browser is deemed fraudulent.

13. The method as claimed in claim 9, wherein the first computer is a server.

14. The method as claimed in claim 9, wherein the second computer is a server.

15. A method of determining the legitimacy of the selection of a linked advertisement, the method comprising:
transmitting a cookie from a user agent to a content server;
updating information in the cookie at the content server;
generating a receipt configured for an advertiser, the receipt including information pertaining to activity of a user who selects a linked advertisement;
analyzing the receipt; and
generating a bid based on the analysis of the receipt.

16. The method of claim 15, wherein the cookie is a mutating cookie.
